(19) United States
(12) Patent Application Publication
(10) Pub. No.: US 2026/0187111 A1
(43) Pub. Date: Jul. 2, 2026

(54) Information Gathering Using an Intake Artificial Intelligence Agent

(71) Applicant: Maplebear Inc., San Francisco, CA (US)

(72) Inventors: Benjamin Bernard, Brier, WA (US); Spencer Lee Cohen, Wilmington, NC (US); Kevin Lei, Indianapolis, IN (US); Helena Ursic Vrabec, Princeton Junction, NJ (US); Taylor Hohenberger, Poolville, TX (US); Robert Bowering, Kitchener (CA); Junghoon Lee, Richmond Hill (CA)

(21) Appl. No.: 19/006,060

(22) Filed: Dec. 30, 2024

(51) Int. Cl. G06F 16/3329; G06F 16/34

(52) U.S. Cl. CPC G06F 16/33295; G06F 16/345

(57) ABSTRACT

A question is posed by a user of a user device as part of an online chat session with an online system. An intake artificial intelligence (AI) agent interacts with the user via the online chat session in one or more rounds of messaging to gather information that may be used by a human agent to respond to the question. At some point, the online system may identify in an output of the intake AI agent an indication that there is sufficient context regarding the question to transfer the question to the human agent. The online system provides session information (e.g., the question and gathered context) to a user device associated with the human agent. The human agent may use the session information to develop a response to the question that may be provided to the user.

### BACKGROUND

Artificial intelligence (AI) chatbots may be used to provide answers to user questions. These AI chatbots are sometimes powered by models (e.g., large-language models). One issue with AI chatbots is that the underlying models can hallucinate, which is particularly problematic in situations where the standard for accuracy is very high (e.g., answering legal questions). Another issue is that a user may ask a question, but does not provide enough context in order for the question to be answered accurately by the AI chatbot. For these reasons, human agents are often used to answer questions. However, in the case of human-to-human interactions, gathering context to fully answer a question often results in a lot of back and forth between the person asking the question and the human agent who provides the answer to the question. The back and forth is often due to the question, as initially posed to the agent, not having enough context, resulting in the agent having to gather additional context about the question from the person in order to provide an accurate answer. And as human-to-human interactions may occur in an asynchronous manner (e.g., as a series of emails sent at different times), gathering enough context to answer a question can take a relatively long time (e.g., days).

### SUMMARY

In accordance with one or more aspects of the disclosure, information gathering using one or more intake artificial intelligence (AI) agents is described. In some embodiments, a user device associated with a user may be in an online chat session with an AI intelligence agent of an online system. The user may pose a question as part of the online chat session. The online system maintains the online chat session, and the online chat session includes one or more rounds of messaging between the user and the intake AI agent to gather context that can be used by a human agent to respond to the question.

A round of messaging may include, e.g., receiving, from the user device, a message that includes some amount of context associated with the question. The online system may prompt the intake AI agent with: (1) a history of the messaging, (2) guidelines for responding to questions in a particular domain, and (3) a definition of a response format, to generate an output in the response format (e.g., extensible markup language document) for responding to the prompt. The output may include an indication of whether enough context regarding the question has been gathered to transfer the question to a human agent and an indication of a next message (e.g., follow-up question) to send back to the user device. The online system may provide a message to the user device in accordance with the indication of the next message.

At some point (e.g., in a most recent round of messaging of the one or more rounds of messaging), the online system may identify in an output of the intake AI agent an indication that there is sufficient context regarding the question to transfer the question to the human agent. The online system provides session information (e.g., the question and gathered context) to a user device associated with the human agent. The human agent may use the session information to develop a response to the question that may be provided to the user. In some embodiments, the human agent may provide the response to the question as part of the online chat session. In other embodiments, the human agent may provide the response to the question via a communication channel (e.g., email, phone, etc.) sometime after the online chat session has terminated.

The structured nature of the prompt and the response format (e.g., extensible markup language document) is such that it helps mitigate potential hallucinations of the intake AI agent. Additionally, the structure of the prompt and the response format helps to ensure the intake AI agent accurately gather context at the appropriate level (e.g., ensuring follow up questions are fully answered) versus simply recording a response to a question. This may ensure that the intake AI agent is able to gather enough context for the human agent to accurately and fully answer a question from a user before transferring the question to the human agent. Moreover, the intake AI agent is able to gather context about a user question during a single online chat session that can then be handed off to the human agent to answer in a time efficient manner.

### BRIEF DESCRIPTION OF THE DRAWINGS

FIG. 1 illustrates an example system environment for an online system that is part of an organization, in accordance with one or more embodiments.

FIG. 2 illustrates an example system architecture for an online system, in accordance with some embodiments.

FIGS. 3A-3B form an example sequence diagram describing information gathering using an intake artificial intelligence agent, in accordance with some embodiments.

FIG. 4A is a block diagram of an example prompt for an intake artificial intelligence agent, according to one or more embodiments.

FIG. 4B is a block diagram of a response schema section of FIG. 4A.

FIG. 5 is a flowchart for a method of information gathering using an intake artificial intelligence agent, in accordance with some embodiments.

### DETAILED DESCRIPTION

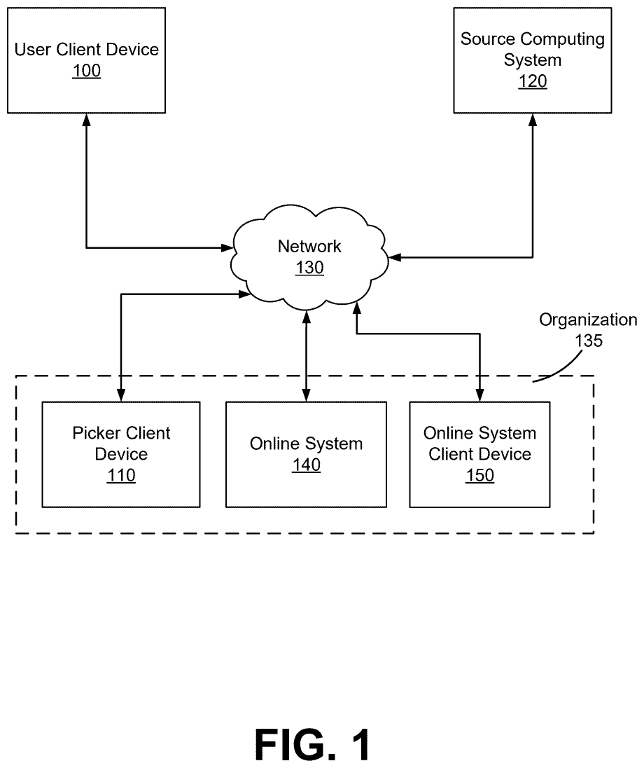

FIG. 1 illustrates an example system environment for an online system 140 that is part of an organization 135, in accordance with one or more embodiments. The system environment illustrated in FIG. 1 includes a user client device 100, a picker client device 110, a source computing system 120, a network 130, an online system 140, and an online system client device 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The organization 135 includes the online system 140, the online system client device 150, and the picker client device 110. Although one user client device 100, picker client device 110, and source computing system 120 are illustrated in FIG. 1, any number of users, pickers, and sources may interact with the online system 140. As such, there may be more than one user client device 100, picker client device 110, or source computing system 120. Similarly, although one online system client device 150 is illustrated in FIG. 1, there may be more than one online system client device 150.

The user client device 100 is a client device through which a user may interact with the picker client device 110, the source computing system 120, the online system client device 150, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the online system client device 150, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The organization 135 is an entity (e.g., business entity) that operates the online system 140. The organization 135 may be composed of various groups (e.g., engineering, sales, marketing, legal, logistics, information technology (IT) support, etc.), where each group performs a particular function for organization 135. Members (e.g., employee, contractor) of the various groups may communicate with the online system 140 or other members of the organization 135 via online system client devices (e.g., the online system client device 150). An online system client device 150 can be a personal or mobile computing device, such as a smartphone, a tablet, a laptop computer, or desktop computer. In some embodiments, the online system client device 150 executes a client application that uses an API to communicate with the online system 140.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

A user device is a device that an associated user may use to interact with the online system 140. A user device may be, e.g., the user client device 100, the picker client device 110, the online system client device 150, or some combination thereof. A human agent of the organization 135 is a user who answers questions from other users of user devices. The human agent may use a user device (e.g., the online system client device 150) to answer the questions from the other users.

A user device may join an online chat session with the online system 140. The user of the user device may submit a question to the online system 140 during the online chat session. As described in detail below, the online chat session is initially between the user and an intake artificial intelligence (AI) agent of the online system 140. The intake AI agent gathers context about the question, and once there is enough context, transfers the question and context to a human agent to answer the question. For example, during the online chat session, the user device may receive from the online system 140 messages that include one or more follow up questions on the question originally submitted by the user. The one or more follow up questions may be to gather additional context that may be useful in developing a response (e.g., answering) to the question. The user may answer the one or more follow up questions and provide (via the user device) the answers as part of the online session to the online system 140. At some point, the user device receives a notification from the online system 140 that the question is being transferred to a human agent. The user device may receive an answer to the question during the online chat session, at a later time via a communication channel (e.g., email, phone, text, a different online chat session, etc.), or some combination thereof.

In some embodiments, the user device may receive from the online system 140 a summary of the message history of the online chat session. The summary describes the question and additional context (e.g., associated with the question) gathered during the online chat session. The user device may present the summary along with an option to provide feedback regarding the summary. The option to provide feedback may be, e.g., a means (e.g., soft button) to approve or reject the summary. In some embodiments, the option may include one or more fields to add additional context. Once the user provides feedback, the user device may provide the feedback to the online system 140.

The online system 140 processes questions from users associated with user devices. The questions may be received as part of online chat sessions with the user devices. The online system 140 maintains online chat sessions between user devices and the online system 140. Each online chat session includes one or more rounds of messaging between a user of the user device and an intake AI agent (e.g., a large-language model). In some embodiments, different AI agents participate in different online chat sessions. For example, one AI agent may specialize in tech support and gather context regarding questions in that domain, and a different AI agent may specialize in privacy questions and gather context regarding questions in that domain. During the one or more rounds of messaging, an intake AI agent receives a question from a user device, and proceeds to gather context (e.g., via one or more follow up questions for the user) that may be useful to answer the question.

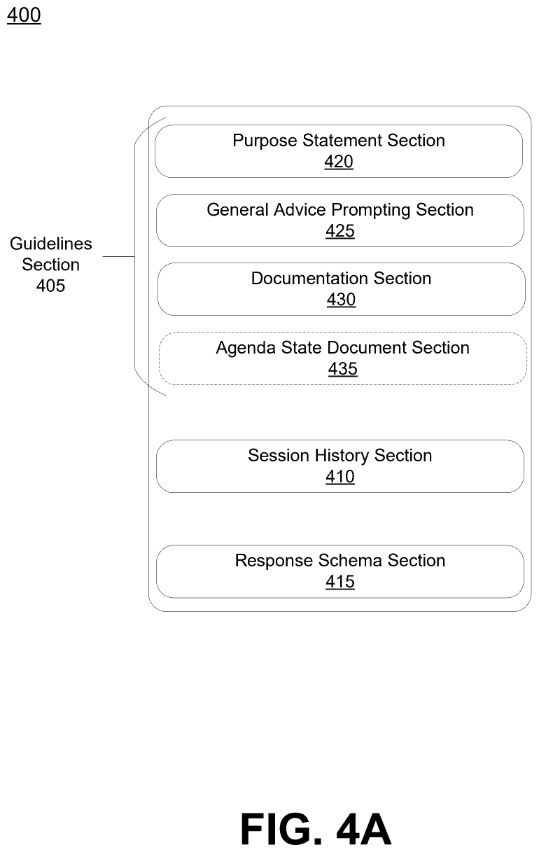

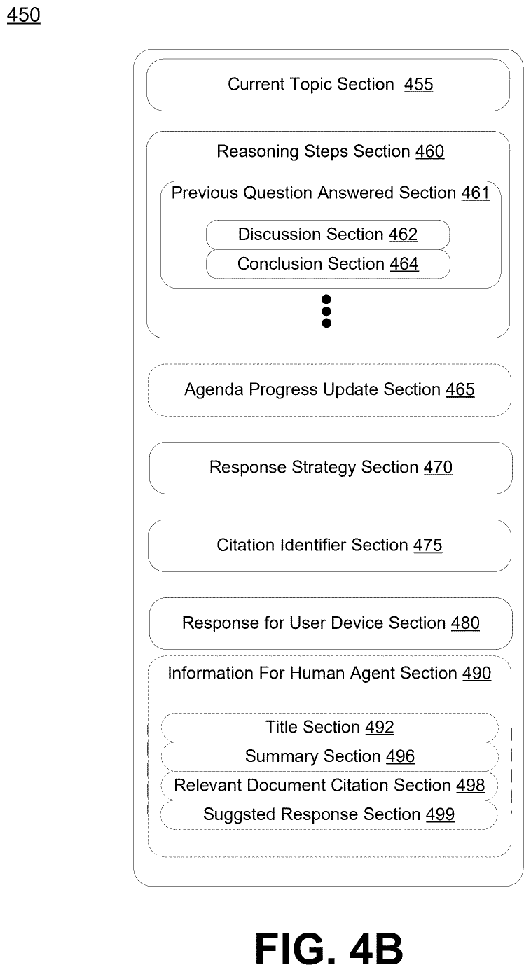

A round of messaging may include receiving (e.g., from a user device) a message that includes some amount of context associated with a question or the question. For example, in a first round of messaging, the message may include the question the user would like answered. In subsequent rounds of messaging, the message from the user device may include additional context to the question. In some embodiments, the additional context may be answers to follow up questions provided to the user device in a previous round of messaging. Responsive to receiving the message, the online system 140 may prompt an intake AI agent to generate an output in a response format (e.g., extensible markup language document) for responding to the prompt. The output may include, e.g., an indication of whether enough context regarding the question has been gathered to transfer the online chat session to a human agent, and an indication of a next message to send back to the user device. Example embodiments of the prompt and response format (i.e., a response schema) are described in detail below with regard to FIGS. 4A and 4B. The online system 140 may then provide a message to the user device in accordance with the indication of the next message output from the intake AI agent. The next message may be, e.g., a follow up question (e.g., to gather additional context about the question), a message requesting feedback on a summary of the messaging, a notification that the question is being transferred to a human agent, or some combination thereof.

In some embodiments, responsive to an indication that there is sufficient context regarding the question to transfer the question to a human agent, the intake AI agent may generate a summary and provide it to the user device. If the user rejects the summary, one or more additional rounds of messaging with the intake AI agent may occur to further refine the context for the question. In some embodiments, responsive to receipt of the user approval of the summary, the online system 140 may assign a human agent to the question, and transfer session information (e.g., the question along with the context) to an online system client device 150 associated with the human agent.

In some embodiments, responsive to the indication being there is sufficient context to transfer the question to the human agent, the online system 140 may automatically assign a human agent to the question and transfer the session information to an online system client device 150 associated with the human agent.

In some embodiments, responsive to the indication being there is sufficient context to transfer the question to the human agent, the online system 140 may prompt the intake AI agent to generate a suggested response to the question based in part on the context gathered from the one or more rounds of messaging. In this embodiment, the online system 140 may provide session information that includes the question, the context, and the suggested response to an online system client device 150 associated with the human agent.

The human agent reviews the session information (e.g., the question and associated context) provided by the intake AI agent. The human agent determines a response to the question based in part on the context. The human agent may then instruct the online system 140 (e.g., via the online system client device 150) to provide the response to the user device. In some embodiments, the human agent may also use citations or a suggested response (e.g., both of which may be in the session information) received from the intake AI agent to determine a response to the question. For example, in some embodiments, the online system client device 150 associated with the human agent may present a suggested response along with an option for the human agent to approve or disregard the suggested response. And if the human agent approves the suggested response, the online system client device 150 may coordinate with the online system 140 to provide the approved response to the user device.

In some embodiments, the human agent is able to provide the response to the user device during the online chat session. In other embodiments, the human agent provides the response to the user device sometime after the online chat session via a communication channel (e.g., email, phone, etc.). For example, once the online system 140 transfers the question to the human agent, it may also notify the user device of the transfer and let them know a ticket has been created for their question and that the human agent will be contacting them at a later time to resolve their question.

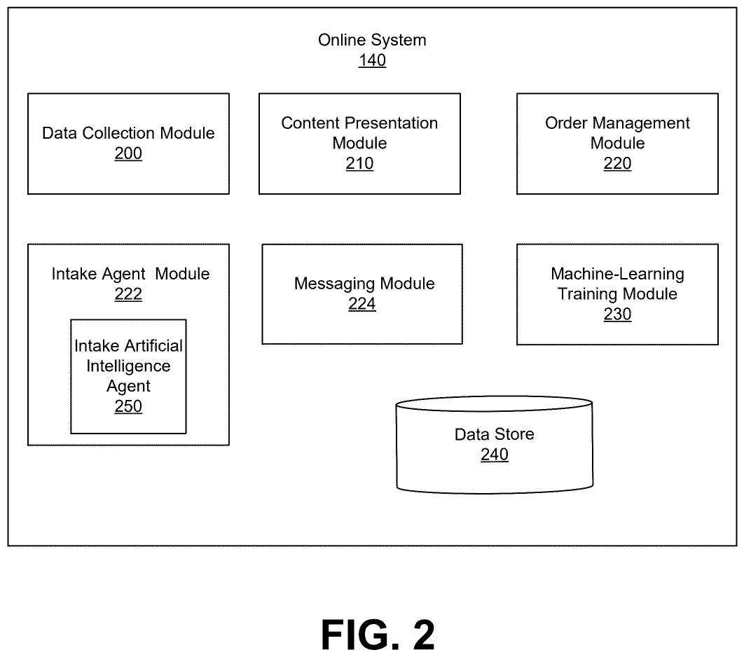

In some embodiments questions may come from user devices that are not part of the organization 135 (e.g., the user client device 100). In other embodiments, questions may come from user devices that are part of the organization (e.g., the online system client device 150). For example, a user who is a member of one group (e.g., engineering) of an organization 135 may have a question that is answered by a member of another group (legal) of the organization 135. The user may establish (via an online system client device) an online chat session with the online system 140, and provide a question to the intake AI agent. One or more rounds of messaging may occur between the intake AI agent and the user, until the intake AI agent outputs an indication that there is sufficient context regarding the question to transfer the question to a human agent. The online system 140 may assign a human agent to the question, and then transfer the question and associated content (e.g., gathered context, citations, suggested answer, etc.) to the human agent. The human agent may then review the question and content to determine an answer. The human agent may provide the answer to the online system client device of the user (e.g., via the online chat session, or via some other communication channel). The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, an intake agent module 222, a messaging module 224, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The data collection module 200 collects service data. Service data is data that is associated with questions from users of user devices. Service data may include, e.g., questions received from user devices, responses to the questions, feedback on responses to the questions, prompts provided to intake AI agents, responses of intake AI agents, some other data associated with the questions, or some combination thereof.

While user data, picker data, source data, item data, service data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The intake agent module 222 may be used to create and manage one or more AI agents. In the illustrated embodiments, the intake agent module 222 includes an intake AI agent 250. The intake AI agent 250 may be composed of one or more machine-learning models (e.g., large-large language models). While a single intake AI agent 250 is illustrated in FIG. 2, in other embodiments, there may be a plurality of intake AI agents. For example, different groups of the organization 135 may have different intake AI agents (e.g., an intake AI agent for legal questions, and a separate intake AI agent for customer service). In some embodiments, a single group of the organization 135 includes a plurality of intake AI agents.

The intake agent module 222 may provide an agent interface to a user device (e.g., the online system client device 150) of the organization 135 for creation of an intake AI agent, management of an intake AI agent, or both, of one or more intake AI agents. The agent interface (e.g., a graphical user interface) may be used to, e.g., name an intake AI agent, upload documents for use by the intake AI agent, manage uploaded documents, upload agendas, manage upload agendas, identify human agents to for the intake AI agent to transfer questions, etc. The documents are materials that a human agent may use in developing a response or reviewing a suggested response to a question from a user. A document may be associated with one or more domains of knowledge. In some embodiments, a domain is specific to a particular group within the organization 135. For example, the domain may be privacy, and the documents may include, e.g., various legal privacy case law, company policies that describe aspects of privacy, etc. An agenda is a listing of specific information that has to be gathered before an intake AI agent transfers a question from a user of a user device to a human agent. For example, an agenda for a product change request may include questions (i.e., agenda items) like, e.g., “What is a risk level in not making the requested change?,” “How much impact will make the change have?,” etc., that are to be answered prior to transferring the question (and the answers to the agenda items) to a human agent. Or it may be an agenda for IT support, and include questions like, e.g., “what operating system are you running?”, “did you re-boot your computer?”, etc., that are to be answered prior to transferring the question (and the answers to the agenda items) to a human agent. In this manner, an agenda may be used to provide specific guidance to an intake AI agent regarding what information has to be collected before transferring session information (e.g., the questions, answers to the agenda items, etc.) to a human agent.

The intake agent module 222 may receive one or more documents for the intake AI agent 250 via the agent interface. The received documents are used in prompts for the intake AI agent 250. The intake agent module 222 may process the received documents such that each document is divided into a plurality of chunks (with corresponding content) and each chunk has its own citation. A citation may reference or link to a particular section of a particular document.

The intake agent module 222 may receive an agenda for the intake AI agent 250 via the agent interface. The intake agent module 222 may process the agenda by identifying agenda items in the agenda and their associated descriptions. The intake agent module 222 may generate an agenda state document for the agenda, where the agenda state document includes the identified agenda items and their associated descriptions, and a status field for each of the identified agenda items. The status field may be used to indicate whether or not an agenda item has been addressed. The agenda state document may be, e.g., an extensible markup language (XML) document.

As part of the intake process, the intake agent module 222 may tokenize the received documents or agendas. For a particular intake AI agent, there may be thousands of tokens generated from uploaded documents or agendas. The agent interface may present for items to be used by an intake AI agent a number of tokens that correspond to the documents or agendas, and offer an option to condense the documents or agendas to reduce the number of tokens. In some embodiments, the agent interface may also present, for a given document or agenda, a textual representation of the document or agenda as it appears to the intake AI agent. This can be useful, e.g., if the document or agenda is of a type (e.g., slide deck) that is not able to be easily parsed by the intake AI agent as it provides a visual indication to a user that the uploaded document or agenda is likely not of much use to the intake AI agent. The user can then decide whether or not to remove the uploaded document or agenda.

The messaging module 224 may communicate with user devices via one or more communication channels. A communication channel may be, e.g., an online chat session, email, phone, text, some other means of communicating with the user device, or some combination thereof. The messaging module 224 receives requests from user devices to commence respective online chat sessions, and establishes online chat sessions with the user devices. The messaging module 224 maintains the online chat sessions with the user devices. An online chat session includes one or more rounds of messaging between a user device and the intake AI agent 250.

The messaging module 224 processes questions received from user devices. The messaging module 224 prompts the intake AI agent 250 based on received messages (that include questions) from user devices. The prompt includes guidelines for responding to questions in a particular domain, documentation (e.g., received via the agent interface) for the domain, session history, and a definition of a response format (may also be referred to as a response schema).

The guidelines for responding to questions in a particular domain includes information regarding the role of an intake agent. The guidelines for responding to questions in a particular domain (“guidelines”) may include, e.g., a purpose statement and general advice prompting. In embodiments, where there is an agenda, the prompt also includes a corresponding agenda state document.

The session history describes the one or more rounds of messaging with the user device. The session history may also be referred to as a history of messaging. Messaging module 224 updates the session history prior to prompting the intake AI agent 250. In this manner, a prompt provided to the intake AI agent 250 may always include a complete description of messages received from the user device and messages provided to the user device for a given online chat session.

The definition of the response format are instructions for the intake AI agent 250 regarding how to format a response to the prompt. The definition of the response format instructs the intake AI agent 250 to generate a response (e.g., XML document) that includes a plurality of sections. The sections are to be populated by the intake AI agent 250 based in part on information gathered during the one or more rounds of messaging. The sections include, e.g., a current topic section, a reasoning steps section, a response strategy section (e.g., transfer to human agent, send follow up question), a citation identifier section, a response for user device section. The definition of the response format may also include an agenda progress update section, an information for human agent section, or both. Example embodiments of the prompt and response format are described in detail below with regard to FIGS. 4A and 4B.

In this manner, a response of the intake AI agent 250 includes an indication of a next message to be sent to the user device, as well as an indication of whether there is sufficient context to transfer the question to a human agent. For example, if the intake AI agent 250 determines that there is still some missing context (e.g., if the intake AI agent 250 has not proceeded through all agenda items), the response strategy may be to send a follow up question to the user device asking for information about the next agenda item. In response, the messaging module 224 may receive another message from the user device. The messaging module 224 may update the prompt based on the received message (e.g., update the session history, update an agenda state document), and apply the updated prompt to the intake AI agent 250 which generates another response. In this manner, one or more rounds of messaging may occur between the user device and the intake AI agent 250, as the intake AI agent 250 gathers context for the question.

The messaging module 224 identifies in an output of the intake AI agent an indication that there is sufficient context regarding the question to transfer the question to the human agent. In some embodiments, responsive to the indication that there is sufficient context to transfer the question to the human agent, the online system 140 automatically assigns a human agent to the question and transfers session information (e.g., e.g., the question, the context gathered due to the one or more rounds of messaging) to online system client device 150 associated with the human agent. In some embodiments, in gathering context, the intake AI agent 250 may have identified portions of one or more documents that may be useful in answering the question, and generated citations to the identified portions. As such, in some embodiments, the session information provided to the online system client device 150 associated with the human agent may include the generated citations.

In some embodiments, responsive to an indication that there is sufficient context regarding the question to transfer the question to a human agent, the intake AI agent 250 may generate a summary. The summary describes the question and context gathered during the online chat session. The online system 140 may provide to the user device the summary along with an option to provide feedback (e.g., approve the summary, reject summary) regarding the summary. If the user rejects the summary, one or more additional rounds of messaging with the intake AI agent may occur to further refine the context for the question. Once the user approves the summary, the online system 140 may assign a human agent to the question, and transfer the session information to an online system client device 150 associated with the human agent. The transferred session information may include, e.g., the approved summary.

In some embodiments, responsive to the indication being there is sufficient context to transfer the question to the human agent, the online system 140 may prompt the intake AI agent 250 to generate a suggested response to the question based in part on the context gathered from the one or more rounds of messaging. The intake AI agent 250 may also output citations to documents that support the suggested response. In this embodiment, the online system 140 may provide session information that includes, e.g., the question, the context, the suggested response, and in some cases citations that support the suggested response, to the online system client device 150 associated with the human agent.

The messaging module 224 notifies user devices that their questions have been transferred to human agents. In some embodiments, the messaging module 224 may hand off the online chat session to the online system client device 150 associated with the human agent. In this manner, the human agent may be able to provide an answer to the user device during the online chat session. In other embodiments, the human agent provides the answer to the user device sometime after the online chat session via a communication channel (e.g., email, phone, etc.). For example, once the messaging module 224 transfers the question to the human agent, it may also notify the user device of the transfer and let them know a ticket has been created for their question and that the human agent will contact them with a response.

The online system 140 is able to gather information from a user of a user device via an online chat session in synchronous manner (i.e., parties continually listen for and act upon replies from each other). However, in other embodiments, another communication channel may be used by the AI agent to gather context about a question in a synchronous manner. For example, an intake AI agent may gather context about a question from a user during a phone call instead of an online chat session. One difference is that the messaging module 224 may perform speech-to-text operations on spoken content from the user to generate text messages, and prompt the intake AI agent 250 based in part on the text messages. Likewise, the messaging module 224 may perform text-to-speech operations on messages that are to be provided to the user device to form audio messages, and provide the audio messages to the user device. And while it may be preferable to gather context in a synchronous manner, in some embodiments, the online system 140 may use a communication channel (e.g., email) that gathers context in an asynchronous manner (i.e., parties do not actively monitor for and act upon replies from each other).

The machine-learning training module 230 trains machine-learning models (e.g., models of the one or more intake AI agents) used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large-language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, service data, or order data, which may be referred to respectively as training user data, training picker data, training item data, training service data, and training order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

For example, in some embodiments, the machine-learning training module 230 may train a machine-learning model of an intake AI agent (e.g., the intake AI agent 250) by accessing a set of training examples that includes training service data for a plurality of questions. The training service data includes a plurality of questions and corresponding answers. The machine-learning training module 230 may apply the machine-learning model to the set of training examples to generate a training output corresponding to a set of training responses for at least some of the plurality of questions. The machine-learning training module 230 may back-propagate one or more error terms obtained from one or more loss functions to update a set of parameters of the machine-learning model, and one or more of the error terms are based on a difference between a label applied to a test interaction of the set of training examples and the set of training responses. The machine-learning training module 230 may stop the back-propagation after the one or more loss functions satisfy one or more criteria.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, service data, and picker data for use by the online system 140. The data store 240 also stores trained machine-learning models trained by the machine-learning training module 230 (e.g., the intake AI agent 250). For example, the data store 240 may store the set of parameters for a trained machine-learning model on one or more non-transitory, computer-readable media. The data store 240 uses computer-readable media to store data, and may use databases to organize the stored data. The data store 240 may also store documents or agendas, tokenized documents or agendas, prompts, agenda state documents, messages from user devices, responses output from intake AI agents, some other information used by one or more intake AI agents of the online system 140, or some combination thereof.

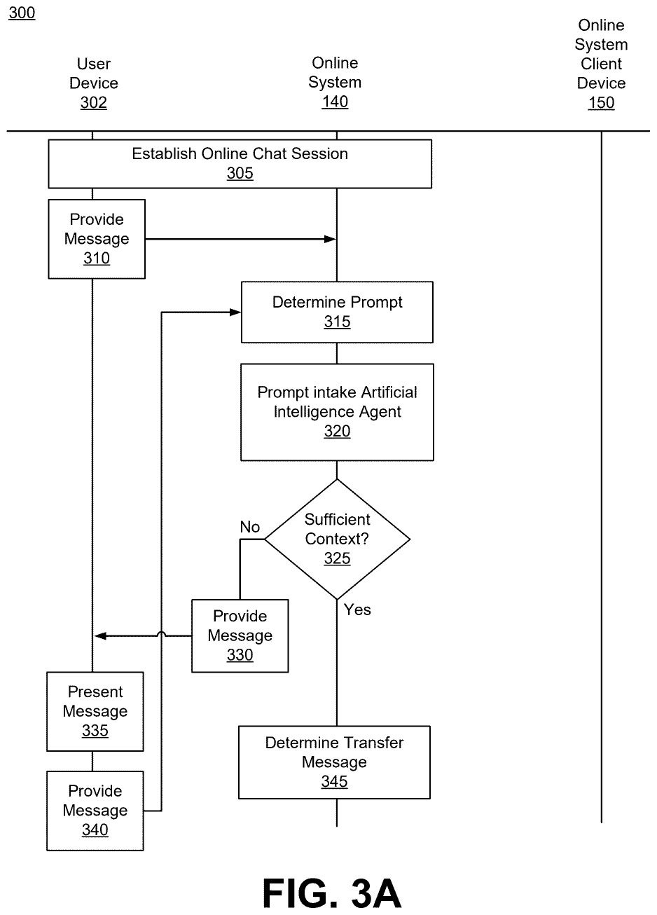

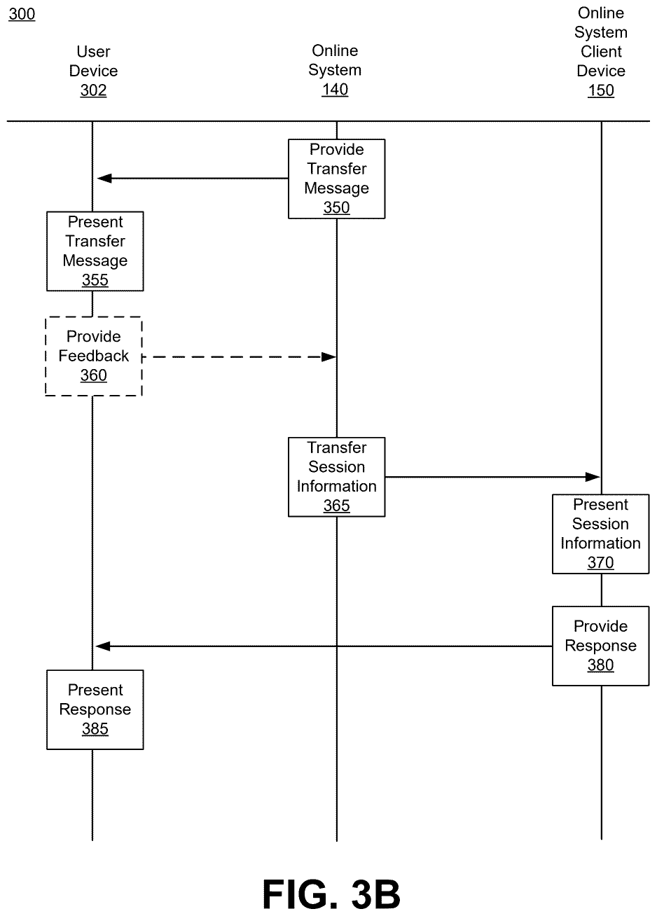

FIGS. 3A-3B form an example sequence diagram 300 describing information gathering using an intake AI agent, in accordance with some embodiments. Alternative embodiments may include more, fewer, or different interactions from those illustrated in FIGS. 3A-3B, and the steps may be performed in a different order from that illustrated in FIGS. 3A-3B.

A user device 302 and the online system 140 establish 305 an online chat session. A user of the user device 302 provides a question for the user device 302 to message via the online chat session to the online system 140. The user device 302 provides 310 the message to the online system 140.

The online system 140 determines 315 a prompt for an intake AI agent (e.g., the intake AI agent 250). The online system 140 may retrieve the prompt from a data store (e.g., the data store 240). The prompt may include, e.g., guidelines for responding to questions in a particular domain, documentation for the domain, session history, and a definition of a response format, and in some embodiments, may also include an agenda state document. An example prompt is discussed below with regard to FIG. 4A. The online system 140 may update portions of the received prompt. For example, the online system 140 may update the session history of the prompt to include information regarding a most recent message provided to the user device 302 or a most recent message received from the user device 302. In some embodiments, the online system 140 may also update the agenda state document of the prompt based in part on a most recent response of the intake AI agent in the online chat session. For example, in a most recent response of the intake AI agent a status may have changed for an agenda item, the online system 140 may update the agenda state document of the prompt to reflect the change in status of the agenda item.

The online system 140 prompts 320 the intake AI agent using the prompt. The online system 140 applies the prompt to the intake AI agent. The intake AI agent outputs a response (e.g., XML document) that is in accordance with the response format prescribed in the prompt. An example response format is discussed below with regard to FIG. 4B. The output of the AI intake agent includes sections of information that have been populated. The sections may include, e.g., a current topic section, a reasoning steps section, a response strategy section (e.g., transfer to human agent, send follow up question), a citation identifier section, and a response for user device section. In embodiments where the prompt includes an agenda state document, the sections may also include an agenda progress update section. In embodiments where the intake AI agent has determined there is sufficient content to transfer the question to a human agent, the sections may include an information for human agent section.

The online system 140 determines 325 whether there is sufficient context for the question to transfer it to a human agent. As noted above, the output of the intake AI agent includes a response strategy field. The response strategy field may be populated with an indication that there is sufficient context and the question is ready to be transferred or an indication to follow up with the user device 302 to gather additional context.

In embodiments, where the indication is to follow up with the user device 302 to gather additional context, the online system 140 may extract a message for the user device 302 from information in the response for user device section of the output of the intake AI agent. In this case, as the intake AI agent has determined to follow up with the user device 302, the message for the user device 302 may include one or more follow up questions. The one or more follow up questions may request additional information from the user. For example, a follow up question may request information in accordance with an agenda item, may request the user clarify the question that was provided to the online system 140, may request the user clarify a response to a previous follow up question, may request the user provide some additional information that the intake AI agent has determined would be useful in answering the question, etc.

The online system 140 may provide 330 the message with the one or more follow up questions to the user device 302 as part of the online chat session. The user device 302 presents 335 the message to the user. The user may then respond to the one or more follow up questions and provide 340, as part of the online chat session, a message that includes the response to the online system 140. Steps 315-340 repeat, until at step 325 it is determined that the output of the intake AI agent has an indication that there is sufficient context to transfer the question to the human agent.

In embodiments, where the output of the intake AI agent includes an indication that there is sufficient context to transfer the question to the human agent, the online system 140 may determine 345 a transfer message for the user device 302 from information in the response for user device section. The online system 140 provides, via the online chat session, the transfer message 350 to the user device. The user device 302 presents 355 the transfer message to the user.

In some embodiments, the transfer message notifies the user of the user device 302 that their question is being transferred to a human agent who can take over the remainer of the online chat session.

In some embodiments, the transfer message may also notify the user that a ticket has been created for their question and that the human agent will be contacting them shortly to resolve their question. In this embodiment, the online chat session may be terminated, as the human agent would review and respond to the question in accordance with their schedule at a later time.

In some embodiments, the transfer message may include a summary of the question and context gathered during the online chat session and an option to provide feedback (e.g., approve the summary, reject summary) regarding the summary. In this embodiment, the user may review the summary, and provide 360 feedback on the summary. If the feedback rejects the summary, the online system 140 may move to step 315 and repeat one or more rounds of messaging to gather additional context regarding the question. In some embodiments, the feedback may include supplemental information provided by the user. If the user approves the summary, the online system 140 may proceed to step 365.

The online system 140 transfers 365 session information to the online system client device 150 associated with the human agent. The session information includes the question and the gathered context. The session information may also include citations to one or more documents that may be relevant to answering the question. In some embodiments, the session information may also include a suggested response to the question. The online system 140 may determine the suggested response using the intake AI agent. For example, the online system 140 may prompt the intake AI agent to generate a suggested response to the question based in part on the question and the context associated with the question that was gathered during the one or more rounds of messaging. In some embodiments, the suggested response output from the intake AI agent further includes citations to at least one document that supports the suggested response.

The online system client device 150 presents 370 the session information to the human agent. The human agent reviews the question and associated context provided by the intake AI agent in the session information. The human agent determines a response to the question based in part on the context. In some embodiments, the human agent may also use citations or a suggested response to determine a response to the question. For example, in some embodiments, the online system client device 150 may present the suggested response along with an option for the human agent to approve or disregard the suggested response. And if the human agent approves the suggested response, the online system client device 150 may coordinate with the online system 140 to provide the approved response to the user device 302.

The online system client device 150 may provide 380 the response to the user device 302. In some embodiments, the online system client device 150 instead provides the response to the online system 140, and the online system 140 provides the response to the user device 302. In some embodiments, the response is provided as part of the online chat session. In other embodiments, the response is provided some time after the online chat session as terminated via a communication channel (e.g., email, online chat session, phone, etc.). The user device 302 presents 385 to the user the response to the question.

The prompt applied to the intake AI agent is highly structured, and the prompt instructs the intake AI agent to output a response in a particular format (e.g., XML document). The structure of the prompt and the response format is such that it helps mitigate potential hallucinations of the intake AI agent. Additionally, the structure of the prompt and the response format helps to ensure the intake AI agent gather context in accordance with the guidelines at the appropriate level (e.g., ensuring follow up questions are fully answered, ensuring that follow up questions are not misunderstood, etc.) versus simply recording a response to a question. This helps ensure that the intake AI agent is able to gather enough context for the human agent to accurately and fully answer user questions. Moreover, the intake AI agent is able to gather context about a user question during a single online chat session, that can then be handed off to the human agent to answer in a time efficient manner. In contrast, conventional approaches of gathering information by a human agent from a user often result in a lot of back and forth (e.g., common in asynchronous communications) between the human agent and the user and can be quite time intensive.

FIG. 4A is a block diagram of an example prompt 400 for an intake AI agent, according to one or more embodiments. The intake AI agent may be, e.g., the intake AI agent 250. The prompt 400 includes a guidelines section 405, a session history section 410, and a response schema section 415. The prompt 400 may be provided in an XML-like syntax. Alternative embodiments may include more, fewer, or different sections from those illustrated in FIG. 4A.

The guidelines section 405 provides guidance for the intake AI agent in gathering context about received questions. The guidelines section may include, e.g., a purpose statement section 420, a general advice prompting section 425, a documentation section 430, and in some embodiments, may also include an agenda state document section 435.

The purpose statement section 420 instructs the intake AI agent as to its role as an intake agent in gathering context about received questions, and once enough has been gathered, transferring the gathered context and question to a human agent. The general advice prompting section 425 provides instruction for the intake AI agent in terms of how to accomplish its role as an intake agent. The documentation section 430 holds documents that are used by the intake AI agent.

The documentation section 430 includes one or more documents that may be used by the intake AI agent 250. The one or more documents may be used by the intake AI agent to, e.g., in determining follow up questions, in determining whether follow up questions have been fully answered, in determining answers to questions, etc. Documents may be added to the documentation section via the agent interface discussed above with reference to FIG. 2. In some embodiments, some or all of the documents in the documentation section 430 are divided into sections (with corresponding content) and each section has its own citation.

The agenda state document section 435 may include an agenda state document. In embodiments, where no agenda was uploaded (e.g., via the agent interface), there is no agenda state document. The agenda state document provides a specific set of agenda items that are to be addressed prior to transferring the question (and gathered context) to the human agent. The agenda state document may be an XML document. The agenda state document includes one or more agenda items, descriptions for the one or more agenda items, and status fields for the one or more agenda items. The status fields indicate whether or not an agenda item has been addressed. The status fields of agenda items in the agenda state document are updated prior to prompting the intake AI agent. In this manner, the agenda state document section 435 may be updated with information from a previous round of messaging before applying the prompt 400 to the intake AI agent.

The session history section 410 stores a session history between the intake AI agent and the user device. The session history describes the one or more rounds of messaging with the user device. The session history section 410 is updated with a current session history prior to prompting the intake AI agent. In this manner, the prompt 400 is updated to include a complete description of messages received from the user device and messages provided to the user device for the online chat session before applying the prompt 400 to the intake AI agent.

The response schema section 415 defines a format of the output of the intake AI agent. The response format instructs the intake AI agent to generate a response as an XML document that includes a plurality of different sections (e.g., current topic section, reasoning section, etc.). The response schema section 415 is described in detail below with regard to FIG. 4B.

FIG. 4B is a block diagram of the response schema section 415 of FIG. 4A. The response schema section 415 includes a current topic section 455, a reasoning steps section 460, a response strategy section 470, a citation identifier section 475, a response for user device section 480. The response schema section 415 may also include an agenda progress update section 465, an information for human agent section 490, or both. Alternative embodiments may include more, fewer, or different sections from those illustrated in FIG. 4B.

As noted above, the response schema section 415 may instruct the intake AI agent to output its response as an XML document having the sections described here.

The current topic section 455 is a section where the intake AI agent specifies a current topic that the intake AI agent is addressing. The intake AI agent may determine this information from, e.g., content of messages received from the user device as part of the online chat session. For example, if the question from the user is IT related, the current topic section may be identifying information about a computer system used by the user.

The reasoning steps section 460 describes steps used by the intake AI agent in responding to a message received from the user device. The reasoning steps section 460 may include one or more sub-fields pertaining to, e.g., follow up questions previously provided to the user device. For example, the reasoning steps section 460 may include a previous question answered section 461 for memorializing whether the intake AI agent has determined whether the previous follow up question sent to the user device was answered in the most recent message from the user device. The previous question answered section 461 may include, e.g., a discussion section 462 and a conclusion section 464. The discussion section 462 is for discussion regarding whether or not the previous follow up question was answered, and the conclusion section 464 is for a conclusion determined by the intake AI agent based on the discussion.

The agenda progress update section 465 is a section that indicates whether one or more agenda items in the agenda state document should be updated. For example, if the intake AI agent has determined that a message from the user device includes information that addresses an agenda item, the agenda progress update section 465 indicates that the agenda item should be updated (e.g., status changed) in the agenda state document section 435 prior to a next prompt of the intake AI agent.

The response strategy section 470 is a section that indicates one or more response strategies to the message from the user device that the intake AI agent has determined to proceed with. The response strategies may include, e.g., transferring to human agent, sending one or more follow up questions, sending a summary of the online chat session to the user device, determining a suggested answer, etc. In some embodiments, a follow up question may be for gathering information on a new topic, may be for gathering additional context on an existing topic, or both.

The citation identifier section 475 is a section for the intake AI agent to memorialize citations to documents it has used during the online chat session.

The response for the user device section 480 is a section for the intake AI agent to place a response to send to the user device. The intake AI agent determines the response to send to the user device and populates the user device section 480 with the determined response. The response is based in part on the response strategy that was written to the response strategy section 470. The response may be, e.g., a message including a follow up question to send to the user device, a message indicating that the question is being transferred to a human agent, a message including a summary of the online chat session to send to the user device, etc.

The information for human agent section 490 is a section that the intake AI agent populates once it has determined that enough context about the question has been gathered to transfer the question to the human agent. The information for human agent section 490 may include, e.g., a title section 492, and a summary section 496. The title section 492 is a section that intake AI agent populates with a title of the request for the human agent. The summary section 496 is a section that the intake AI agent populates with a summary of the question and the context gathered during the online chat session. In some embodiments, the information for human agent section 490 may also include a relevant document citation section 498, a suggested response section 499, or some combination thereof. The relevant document citation section 498 is a section that the intake AI agent may populate with citations to documents that the intake AI agent has determined are relevant to answering the question. The suggested response section 499 is a section that the intake AI agent may populate with a suggested response to the question. In other embodiments, there is no suggested response section 499, and in cases where there is a suggested response, it is placed within the summary section 496.

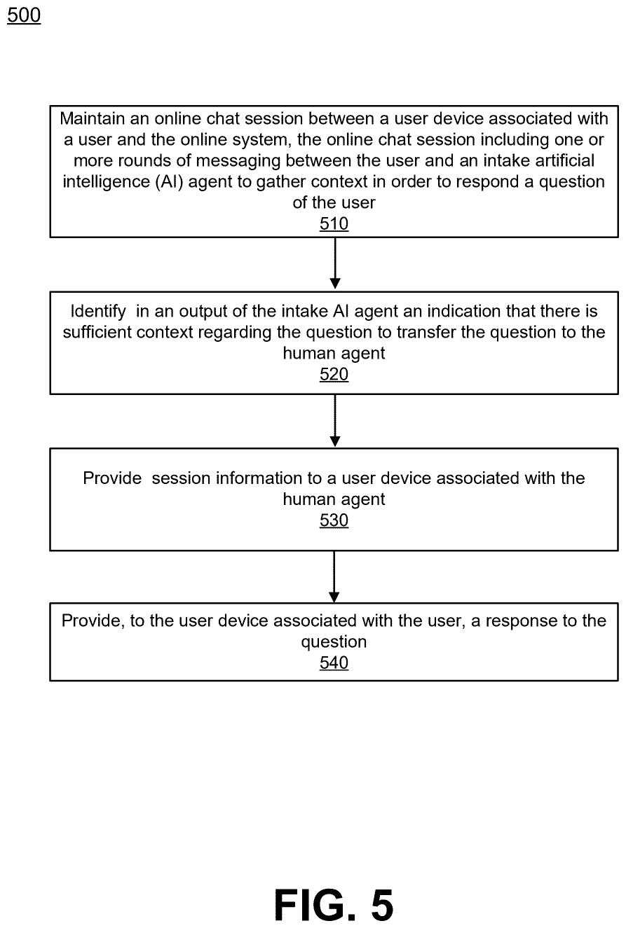

FIG. 5 is a flowchart 500 for a method of information gathering using an intake AI agent, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system maintains 510 an online chat session between a user device associated with a user and the online system. The online chat session includes one or more rounds of messaging between the user and an intake AI agent to gather context in order to respond to a question of the user.

A round of messaging may include, e.g., receiving, from the user device, a message that includes some amount of context associated with the question (e.g., the question, information that may be used to develop a response to the question, etc.). The online system may prompt the intake AI agent with: (1) a history of the messaging, (2) guidelines for responding to questions in a particular domain, and (3) a definition of a response format, to generate an output in the response format. The output may include an indication of whether enough context regarding the question has been gathered to transfer the question to a human agent and an indication of a next message to send back to the user device. The online system may provide a message to the user device in accordance with the indication of the next message.

The online system identifies 520, in an output of the intake AI agent, an indication that there is sufficient context regarding the question to transfer the question to the human agent. For example, the response format of the intake AI agent may include a response strategy section. The online system may identify in the response strategy section that the intake AI agent has determined that there is sufficient context to transfer the question to the human agent.

The online system provides 530 session information to a user device (e.g., an online system client device 150) associated with the human agent. The session information includes the question and context gathered about the question based in part on the online chat session. In some embodiments, the session information may also include, e.g., citations to one or more documents that the intake AI agent has identified as being relevant to answering the question. In some embodiments, the intake AI agent may also have determined a suggested response, and the session information includes the suggested response. In some embodiments, the intake AI agent may also have determined one or more citations to one or more documents that support the suggested response, and the session information includes the suggested response.

The human agent reviews the session information, and determines a response to the question. In some embodiments, the user device associated with the human agent may present a suggested response along with an option for the human agent to approve or disregard the suggested response. And if the human agent approves the suggested response, the user device may coordinate with the online system to provide the approved response to the user device associated with the user.

The online system provides 540, to the user device associated with the user, a response to the question. In other embodiments, the user device associated with the human agent may provide the response to the user device associated with the user. In some embodiments, the response is provided as part of the online chat session. In other embodiments, the response is provided some time after the online chat session has terminated via a communication channel (e.g., email, online chat session, phone, etc.).

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computer system comprising a processor and a computer-readable medium, comprising:
receiving a question from a client device associated with a user of an online system;
identifying a particular domain associated with the question;
identifying an intake AI agent associated with the particular domain of a plurality of intake AI agents;
accessing guideline documentation associated with the particular domain, wherein the guideline documentation comprises one or more documents describing guidelines for responding to questions in the particular domain;
maintaining an online chat session between a user device associated with a user and an online system, the online chat session including one or more rounds of messaging between the user and the intake artificial intelligence (AI) agent to gather context in order to respond the question of the user, wherein a round of messaging includes:
receiving, from the user device, a message that includes a description of a context associated with the question,
prompting the intake AI agent, wherein prompting the intake AI agent comprises generating a prompt for a generative language model, wherein the prompt for the generative language model comprises (1) a history of the messaging, (2) the guideline documentation, (3) a definition of a response format, and (4) natural-language instructions to generate an output in the response format for responding to the prompt, wherein the output includes a score indicating whether enough context regarding the question has been gathered to transfer the question to a human agent, and a next message to send back to the user device,
receiving a response to the prompt from the generative language model, wherein the response comprises the score and the next message, and
responsive to the score not exceeding a threshold, transmitting a message to the user device in accordance with the indication of the next message;
detecting, in a round of messaging of the one or more rounds of messaging, that a score in a response from the generative language model exceeds the threshold;
responsive to detecting that the score exceeds the threshold, prompting the intake AI agent to generate session information of the online chat session, wherein prompting the intake AI agent comprises generating another prompt for the generative language model, wherein the other prompt for the generative language model comprises a history of the messaging and instructions for the generative language model to generate a summary of the online chat session and the question of the user;
receiving a response from the generative language model, wherein the response comprises the session information, wherein the session information comprises the summary of the online chat session and the question of the user; and
providing the session information to a user device associated with the human agent, the session information including the question and context associated with the question that was gathered during the one or more rounds of messaging.

2. The method of claim 1, further comprising:
prompting the intake AI agent to generate a suggested response to the question based in part on the question and the context associated with the question that was gathered during the one or more rounds of messaging; and
providing the suggested response to the user device associated with the human agent.

3. The method of claim 2, further comprising:
providing, to the user device associated with the human agent, an option to approve the suggested response, wherein responsive to approval of the suggested response, the online system is configured to provide the suggested response to the user device associated with the user.

4. The method of claim 2, wherein the suggested response further includes a citation to a document that supports the suggested response, the method further comprising:
providing the citation to the user device associated with the human agent.

5. (canceled)

6. The method of claim 1, further comprising:
receiving an approval from the user device of the summary,
wherein providing the session information to the user device associated with the human agent is in response to receipt of the approval.

7. The method of claim 1, wherein the guidelines for responding to questions in the particular domain, further comprise:
an agenda including one or more questions used to gather at least some of the context regarding the question, and the round of messaging further comprises:
updating, by the intake AI agent, a status of a question of the one or more questions based in part a message from the user device,
wherein the indication of whether enough context regarding the question has been gathered to transfer the question to the human agent is based in part on statuses of the one or more questions.

8. The method of claim 1, wherein the human agent is part of a group of an organization that includes the online system, the method further comprising:
receiving from a user device associated with the group the guidelines for responding to questions in the particular domain; and
providing the user device associated with the user with a response from the human agent to the question, wherein the user device associated with the user is part of a different group of the organization.

9. A computer program product comprising a non-transitory computer readable storage medium having instructions encoded thereon that, when executed by a processor of a computer system, cause the computer system to perform steps comprising:
receiving a question from a client device associated with a user of an online system;
identifying a particular domain associated with the question;
identifying an intake AI agent associated with the particular domain of a plurality of intake AI agents;
accessing guideline documentation associated with the particular domain, wherein the guideline documentation comprises one or more documents describing guidelines for responding to questions in the particular domain;
maintaining an online chat session between a user device associated with a user and an online system, the online chat session including one or more rounds of messaging between the user and the intake artificial intelligence (AI) agent to gather context in order to respond the question of the user, wherein a round of messaging includes:
receiving, from the user device, a message that includes a description of a context associated with the question,
prompting the intake AI agent, wherein prompting the intake AI agent comprises generating a prompt for a generative language model, wherein the prompt for the generative language model comprises (1) a history of the messaging, (2) the guideline documentation, (3) a definition of a response format, and (4) natural-language instructions to generate an output in the response format for responding to the prompt, wherein the output includes a score indicating whether enough context regarding the question has been gathered to transfer the question to a human agent, and a next message to send back to the user device,
receiving a response to the prompt from the generative language model, wherein the response comprises the score and the next message, and
responsive to the score not exceeding a threshold, transmitting a message to the user device in accordance with the indication of the next message;
detecting, in a round of messaging of the one or more rounds of messaging, that a score in a response from the generative language model exceeds the threshold;
responsive to detecting that the score exceeds the threshold, prompting the intake AI agent to generate session information of the online chat session, wherein prompting the intake AI agent comprises generating another prompt for the generative language model, wherein the other prompt for the generative language model comprises a history of the messaging and instructions for the generative language model to generate a summary of the online chat session and the question of the user;
receiving a response from the generative language model, wherein the response comprises the session information, wherein the session information comprises the summary of the online chat session and the question of the user; and
providing the session information to a user device associated with the human agent, the session information including the question and context associated with the question that was gathered during the one or more rounds of messaging.

10. The computer program product of claim 9, further comprising encoded instructions that when executed cause the computer system to perform steps comprising:
prompting the intake AI agent to generate a suggested response to the question based in part on the question and the context associated with the question that was gathered during the one or more rounds of messaging; and
providing the suggested response to the user device associated with the human agent.

11. The computer program product of claim 10, further comprising encoded instructions that when executed cause the computer system to perform steps comprising:
providing, to the user device associated with the human agent, an option to approve the suggested response, wherein responsive to approval of the suggested response, the online system is configured to provide the suggested response to the user device associated with the user.

12. The computer program product of claim 10, wherein the suggested response further includes a citation to a document that supports the suggested response, the computer program product further comprising encoded instructions that when executed cause the computer system to perform steps comprising:
providing the citation to the user device associated with the human agent.

13. (canceled)

14. The computer program product of claim 9, further comprising encoded instructions that when executed cause the computer system to perform steps comprising:
receiving an approval from the user device of the summary,
wherein providing the session information to the user device associated with the human agent is in response to receipt of the approval.

15. The computer program product of claim 9, wherein the guidelines for responding to questions in the particular domain, further comprise:
an agenda including one or more questions used to gather at least some of the context regarding the question, and the round of messaging further comprises:
updating, by the intake AI agent, a status of a question of the one or more questions based in part a message from the user device,
wherein the indication of whether enough context regarding the question has been gathered to transfer the question to the human agent is based in part on statuses of the one or more questions.

16. The computer program product of claim 9, wherein the human agent is part of a group of an organization that includes the online system, the computer program product further comprising encoded instructions that when executed cause the computer system to perform steps comprising:
receiving from a user device associated with the group the guidelines for responding to questions in the particular domain; and
providing the user device associated with the user with a response from the human agent to the question, wherein the user device associated with the user is part of a different group of the organization.

17. A computer system comprising:
a processor; and
a non-transitory computer readable storage medium having instructions encoded thereon that, when executed by the processor, cause the computer system to perform steps comprising:
receiving a question from a client device associated with a user of an online system;
identifying a particular domain associated with the question;
identifying an intake AI agent associated with the particular domain of a plurality of intake AI agents;
accessing guideline documentation associated with the particular domain, wherein the guideline documentation comprises one or more documents describing guidelines for responding to questions in the particular domain;
maintaining an online chat session between a user device associated with a user and an online system, the online chat session including one or more rounds of messaging between the user and the intake artificial intelligence (AI) agent to gather context in order to respond the question of the user, wherein a round of messaging includes:
receiving, from the user device, a message that includes a description of a context associated with the question,
prompting the intake AI agent, wherein prompting the intake AI agent comprises generating a prompt for a generative language model, wherein the prompt for the generative language model comprises (1) a history of the messaging, (2) the guideline documentation, (3) a definition of a response format, and (4) natural-language instructions to generate an output in the response format for responding to the prompt, wherein the output includes a score indicating whether enough context regarding the question has been gathered to transfer the question to a human agent, and a next message to send back to the user device,
receiving a response to the prompt from the generative language model, wherein the response comprises the score and the next message, and
responsive to the score not exceeding a threshold, transmitting a message to the user device in accordance with the indication of the next message;
detecting, in a round of messaging of the one or more rounds of messaging, that a score in a response from the generative language model exceeds the threshold;
responsive to detecting that the score exceeds the threshold, prompting the intake AI agent to generate session information of the online chat session, wherein prompting the intake AI agent comprises generating another prompt for the generative language model, wherein the other prompt for the generative language model comprises a history of the messaging and instructions for the generative language model to generate a summary of the online chat session and the question of the user;
receiving a response from the generative language model, wherein the response comprises the session information, wherein the session information comprises the summary of the online chat session and the question of the user; and
providing the session information to a user device associated with the human agent, the session information including the question and context associated with the question that was gathered during the one or more rounds of messaging.

18. The system of claim 17, further comprising encoded instructions that when executed cause the computer system to perform steps comprising:
prompting the intake AI agent to generate a suggested response to the question based in part on the question and the context associated with the question that was gathered during the one or more rounds of messaging; and
providing the suggested response to the user device associated with the human agent.

19. (canceled)

20. The system of claim 17, wherein the guidelines for responding to questions in the particular domain, further comprise:
an agenda including one or more questions used to gather at least some of the context regarding the question, and the round of messaging further comprises:
updating, by the intake AI agent, a status of a question of the one or more questions based in part a message from the user device,
wherein the indication of whether enough context regarding the question has been gathered to transfer the question to the human agent is based in part on statuses of the one or more questions.
